(19) United States
(12) Patent Application Publication
(10) Pub. No.: US 2006/0150450 A1
(43) Pub. Date: Jul. 13, 2006

(54) Apparatus and method for delivering media-content, merchandising and products through the inner-space of a bottle

(76) Inventor: Ilan Ovadia Azouri, Tel-Aviv (IL)

Correspondence Address: MAYER & WILLIAMS PC, 251 NORTH AVENUE WEST, 2ND FLOOR, WESTFIELD, NJ, 07090, US

(21) Appl. No.: 11/193,517

(22) Filed: Jul. 29, 2005

Related U.S. Application Data
(60) Provisional application No. 60/592,480, filed on Jul. 30, 2004.

(51) Int. Cl. G09F 3/00

(52) U.S. Cl. 40/310

(57) ABSTRACT

An apparatus that delivers media content and a wide variety of merchandising and products to beverage consumers through a water bottle's inner-space. The apparatus can include various internal cylinders and pockets for containing additives, devices, advertisements etc., within various spaces within the bottle. Cartridges for releasing additives are also discloses.

### CROSS-REFERENCE TO RELATED APPLICATIONS

This application claims the benefit of U.S. Provisional Application No. 60/592,480, filed Jul. 30, 2004.

### FIELD OF THE INVENTION

### BACKGROUND OF THE INVENTION

Media has been delivered through bottles for many years. There are several examples of prior art which are currently in use by beverage and other consumer products companies. These methods include: a banner around the outside of the bottle, which is affixed through paper glued around the outer bottle as a label; text and/or pictures that are chemically “painted” or molded around the outside of the bottle or on the top or underside of the bottle cap of the bottle cap; paper pamphlets and/or advertisements enclosed in a plastic casing and sealed to the outside of the bottle; and a sticker on the outside of the bottle or underside of the cap that can be removed to expose a text and/or art underneath.

Although these methods have been used effectively for many years, they are somewhat limited in their ability to deliver content to consumers. These limitations include: content delivered is limited to text and art and does not include actual products/merchandise (e.g., bulky, fragile or awkward shaped items); certain beneficial substances (e.g., drugs, vitamins, organic or natural products and/or supplements, alternative medicines) cannot be added to water beverages due to shelf stability issues when mixed with water.

Finally, such methods are already well known to consumers and no longer attract attention as effectively.

### SUMMARY OF THE INVENTION

In a first embodiment, the invention provides an apparatus that delivers media content and a wide variety of merchandising and products to beverage consumers through a water bottle's inner-space. In this embodiment, two main parts are employed: (1) a “cylinder” attached to the mouth of a water bottle, flowing downward, within the bottle's inner-space, towards the bottle's base; (2) a “carrier” for merchandising and products. The cylinder may serve certain functions: (1) as a cylindrical “billboard” where media/advertisements can be delivered and seen through the water bottle and also be removed by consumers for reading or functional use; and (2) as a pathway for the “carrier”. The carrier may be a sealed, buoyant, hydro-dynamic container (e.g., test-tube shaped) that contains merchandising and products within and may floats to the top of the bottle's mouth where it can then be safely removed by the consumer to gain access to the carrier's contents.

Advantages of the invention may include one or more of the following. Water within the bottle magnifies the media text and art making both the media printed on the cylinder and the bottle itself more noticeable and attractive to consumers, thereby stimulating demand, e.g., particularly with children. The buoyant container and cylinder can be removed by consumers in order for consumers to drink the beverage, thereby making the content within more attention-grabbing. The device allows for a wider variety of items, e.g., bulky, fragile or awkward-shaped as small toys, food and various supplements and samples etc., to be more efficiently distributed to consumers without affecting the bottle or packaging's outer-shape. Certain beneficial substances can be placed in the compartment until ready to drink by the consumer, thereby preserving the shelf-stability of the substances. The device allows for more text and art to be delivered to consumers than was previously provided for due to the limited shape and size of the outer-bottle, including built-in special media effects using micro-processors, sensors, wireless communication and internet.

In another aspect, the invention is directed to an apparatus that delivers media content and a wide variety of merchandising and products to beverage consumers through a water bottle built in an inner-side external space of the packaging. An embodiment of the invention includes three main parts: (1) a “cylinder” shaped pocket built in the bottle inner-side space of a bottle flowing upwards from the base of the bottle; (2) a “carrier pocket” for merchandising and product storage; and (3) a soft “release point mechanism” for solids, gas, and liquids to be injected, pushed, or inserted into the bottle via the bottle pockets. Certain embodiments may also include a multifunctional cap.

The cylinder may act as a cylindrical “billboard” where media/advertisements with various effects e.g.—self illuminated or with a glow—can be delivered and seen through the water bottle and can also be removed by consumers for reading or any other use. The carrier pocket may act as built-in-bottle storage space that can be sealed and can contain merchandising and products of any type and form and which can be removed by the consumer. Carrier pockets can also contain appropriate “cartridges” with liquid concentrates of any type, or capsules or any other substance, e.g., alternative medicine remedies and herbs within where it can be injected or inserted or pushed-in or released, through various mechanisms, into the bottle, and can be mixed with the bottle contents so that the consumer can benefit by the “fresh” mixture.

A penetration and release point can act as a soft point for any additive products to be released into the bottle.

A multi-functional cap may allow for basic cap functions as well as additional functions such as a built-in storage space for any substances with a release mechanism which allows the insertion of various consumption additives in to the bottle.

Embodiments of the apparatus, which delivers media content, merchandising and products through the bottle's pockets and multifunctional cap, may have certain advantages over the prior art. Inner pockets can be covered and sealed and thus protect the content within from most external environmental conditions and forces and can deliver the advertisements much more safely and cleanly to the consumer. Such inner pockets allows for closure and lock of the contents so content may be delivered “first hand” to the consumer. Media producers can enjoy a new direct distribution channel for media contents and merchandising in a safe way to consumers. Consumers may have the choice to use the full functionality of the bottle or none of them at their own discretion—some may wish to drink the water and not use the “release” function that adds other substances to the bottle. Water within the bottle magnifies the media text and art within the pockets making both the media printed on the cylinder and the bottle itself more noticeable and attractive to consumers, thereby stimulating demand, e.g., particularly with children. Such magnification of the media may allow for added value effects, e.g. self-illumination and glow may be offered to consumers which makes the product more attention-grabbing. The device allows for a wider variety of items, e.g., bulky, fragile or awkwardly-shaped, to be more efficiently distributed to consumers nearly without affecting the bottle or packaging outer-shape for distribution. Certain beneficial substances can be placed in the carrier pocket until ready to drink by the consumer, thereby preserving the shelf-stability of the substances. In this way, the consumer can make their own decision about whether to use whatever is in the carrier. As a media channel this allows for more text and art to be delivered to consumers than was previously limited by the shape and size of the outer-bottle, including built-in special media effects using micro-processors, sensors, wireless communication and internet.

### BRIEF DESCRIPTION OF THE DRAWINGS

FIG. 1 shows an embodiment of a carrier which may be used in the current invention.

FIG. 2(A)-(C) shows a bottle, water-resistant sheet, and cylinder banner according an embodiment of the current invention.

FIG. 3 shows the embodiments of FIGS. 1 and 2 combined together.

FIG. 4 shows another embodiment of the invention in which a cylinder-shaped pocket is shown with a bottle.

FIG. 5 shows a bottom view of the embodiment of FIG. 4.

FIG. 6 shows another embodiment of the current invention in which a bottle is shown with a bottom pocket.

FIG. 7 shows another embodiment of the current invention in which a bottle is shown with a side and bottom pocket.

FIGS. 8, 9, and 10 show side, cartridge, and bottom views of another embodiment of the current invention in which a bottle is shown with a bottom pocket.

FIG. 11 shows a perspective view of a multi-functional cap according to another embodiment of the current invention.

### DETAILED DESCRIPTION

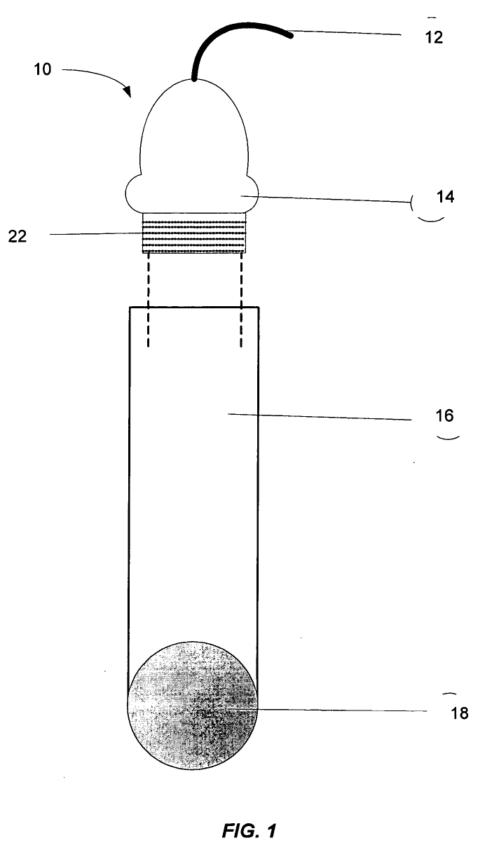

Referring to FIG. 1, a carrier 10 is shown in profile having a pull tab 12, a buoy-stopper 14, a compartment 16, an anchor 18, and a closure device 22. The carrier 10 has its buoyancy controlled by the anchor 18 affixed at the bottom-end and an adjustable buoy-stopper 14. The buoy-stopper 14 is hydro-dynamically shaped so that the carrier can float to the top of the bottle's mouth. The buoy-stopper 14 is buoyant and has a pull tab 12 at the top, so that consumers can safely and easily remove the carrier 10 and use the items within its compartment 16, which may be food/beverage samples, toys, energy drinks, flower essences, etc.

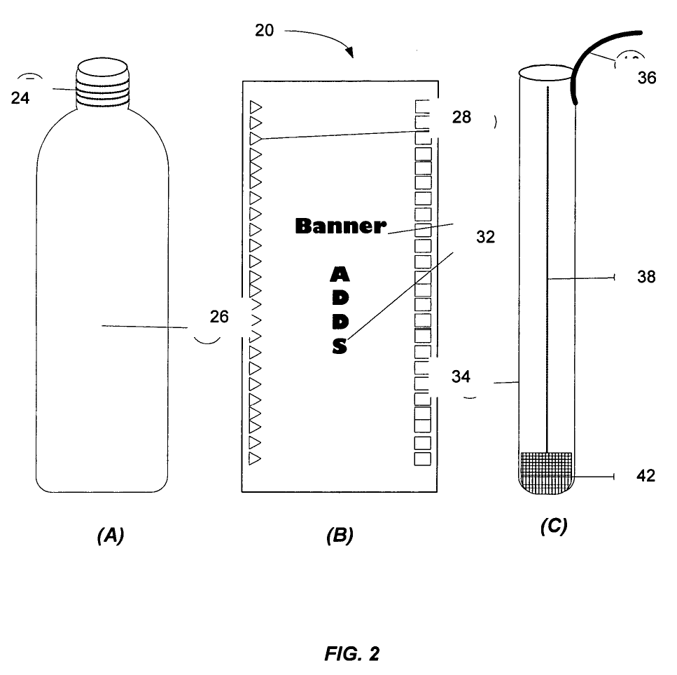

Referring to FIG. 2, 2(A) is a view of a model bottle; 2(B) is a view of a water-resistant sheet that may be rolled to make the cylinder used as a banner; and 2(C) is the sheet rolled and interlocked into the shape of the cylinder.

In more detail, a water resistant sheet 20 is provided that interlocks into a cylinder shape 34. The sheet 20 can contain advertising or other media messages on both sides of the sheet. A porous base 42 of the cylinder-shaped sheet 20 may be employed to keep the cylinder's shape and to prevent the carrier 10 from falling to the bottom if the sheet 20 is shorter than the length of the bottle and/or if the bottle is turned upside down. An adhesive pull-tape 36 may be employed at the top of the sheet 20, affixed to a mouth 24 of the bottle, so that consumers can safely and easily remove the sheet 20.

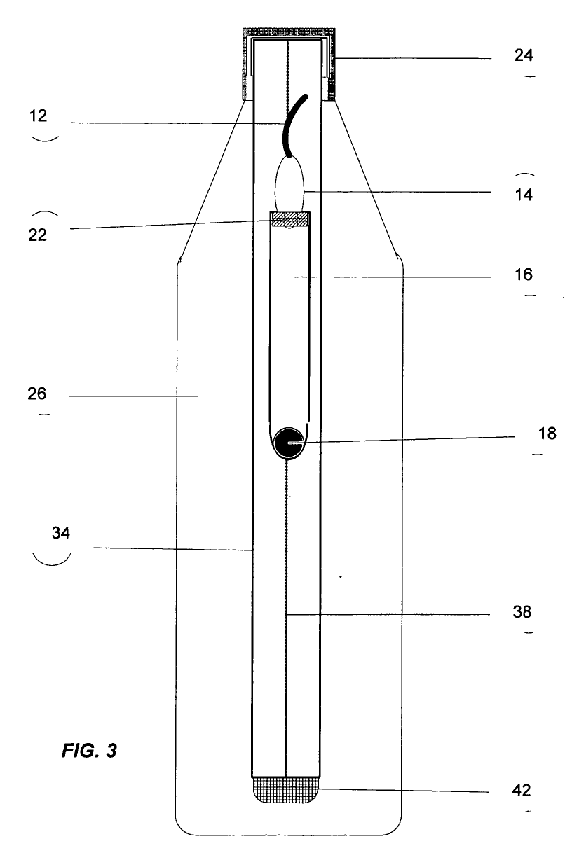

Referring to FIG. 3, a consolidated view is shown of an embodiment of the invention applied to a model bottle.

The components of this embodiment may be assembled in the following manner.

The water-resistant sheet 20 containing ads or other images 32 is formed into the shape of a cylinder 34 by interlocking the edges of the sheet through any type of interlocking mechanisms 28. The porous base 42 may then be affixed to the bottom of the sheet 20. The sheet 20 may be inserted into the bottle so that the top of the sheet 20 fits into the mouth 24 of the bottle and reaches close to the top end of the mouth 24, which then supports the sheet 20.

The adhesive pull tape 36 is then affixed to the mouth 24 of the bottle. An anchor 18 is affixed to the bottom of the compartment 16 if desired, according to desired buoyancy properties. The merchandising and/or product inserts are placed into the compartment 16. The appropriate buoyancy specifications are determined and the buoy-stopper 14 seals the compartment 16. The carrier 10 is inserted into the bottle's inner-space 26 within the cylinder formed by the sheet 20. The bottle may then be closed by the manufacturer.

The components may be used by consumers in the following manner to achieve the desired result. The consumer opens the bottle cap. The carrier floats up just above the mouth 24 so that the pull tab 12 and the buoy-stopper 14 are exposed and pulled by the consumer to remove the carrier. The buoy-stopper 14 is then removed by the consumer so that the content(s) of the compartment(s) 16 may be accessed. If the content includes a liquid substance (e.g., a flower essence “shot”), the content can then be drank directly from the compartment 16 or poured back into the bottle to modify the beverage. The adhesive pull tape 36 attached to the sheet 20 on one end and on the mouth 24 at the other end is pulled so that the sheet 20 may be removed from the bottle via the mouth 24.

The sheet 20 may be opened by unlocking the interlocking mechanism 28 to reveal the advertising space 32 so consumers can read, listen, view or utilize the multi-media or other content which is on the sheet 20.

There are several alternative methods for using and assembling embodiments of the invention. Embodiments of the invention may be applied to many different types and sizes of containers/beverage combinations other than bottled water and soft-drinks, including spirits, wine, beer, milk and juice bottles/cartons and personal care/cosmetics, detergents or any other liquid in containers. Embodiments of the invention can be bifurcated into two parts which can be used in a mutually exclusive manner (i.e., sheet 20 and carrier 10 can be used as stand-alone components to deliver the requisite media, merchandising and/or products. The sheet 20 can be made without the interlocking mechanism 28—either with a sealant or manufactured as a whole piece. The sheet 20 and/or carrier 10 can have its own source of electrical power, using technologies such as “power paper” as well as built-in microprocessors for multi-media effects (e.g., illumination, sound, holograms, etc.). The carrier 10 can be subdivided into one or more compartments 16 via solid or porous subdivisions for wet and/or dry substances (e.g., minerals, crystals). The carrier 10 can also be utilized as a banner advertisement. For commercial and/or safety purposes, a wire can be attached to the carrier, linking the same to the underside of the bottle cap. The carrier can carry any merchandising and/or products, including but not limited to: toys, coupons, confections, food samples, drugs, jewelry, images from movies, lottery tickets, rebates, gemstones, personal care/cosmetic products, food/beverage supplements/flavors, alternative medicine samples, cellular and wireless communication devices. Various materials, sizes, shapes, interconnections, colors, etc. can be used for all components.

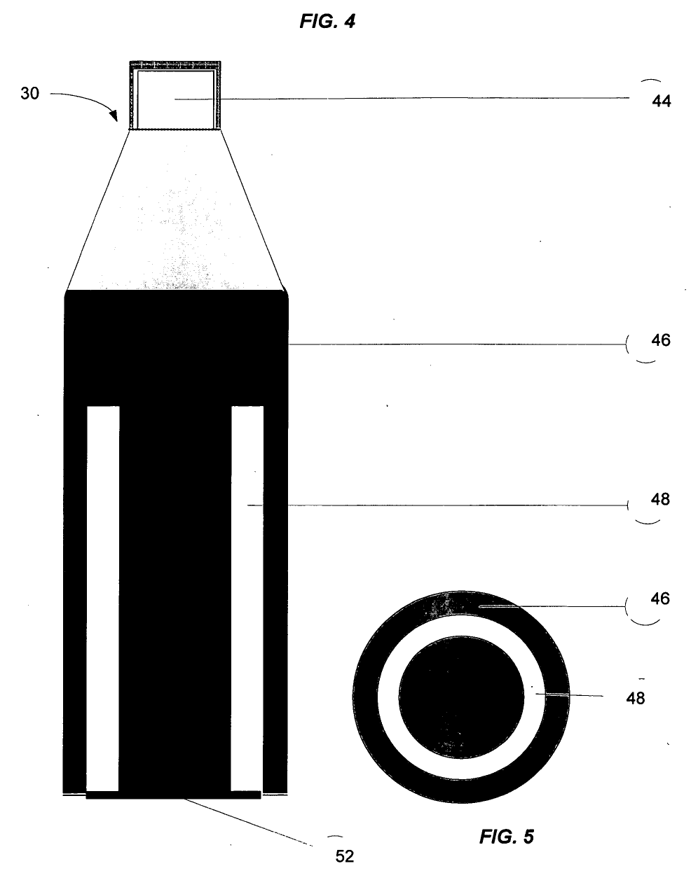

FIG. 4 shows a profile view of the cylinder-shaped pocket in a bottle. In this embodiment, a bottle 30 includes a cap 44, which may be multifunctional. Cap 44 closes the bottle which has an inner space or volume 46. Within the inner space 46 a pocket inner space 48 is defined by a hollow cylinder disposed in the location shown. Access to the pocket inner space may be via the bottom of the bottom (see FIG. 5, which shows a bottom view of the cylinder-shaped pocket), and may be closed via a pocket cover 52. While the pocket is shown as being accessed from the bottom, such pockets may be situated in any section of the bottle. The cover may be held on by adhesive or by any other such means.

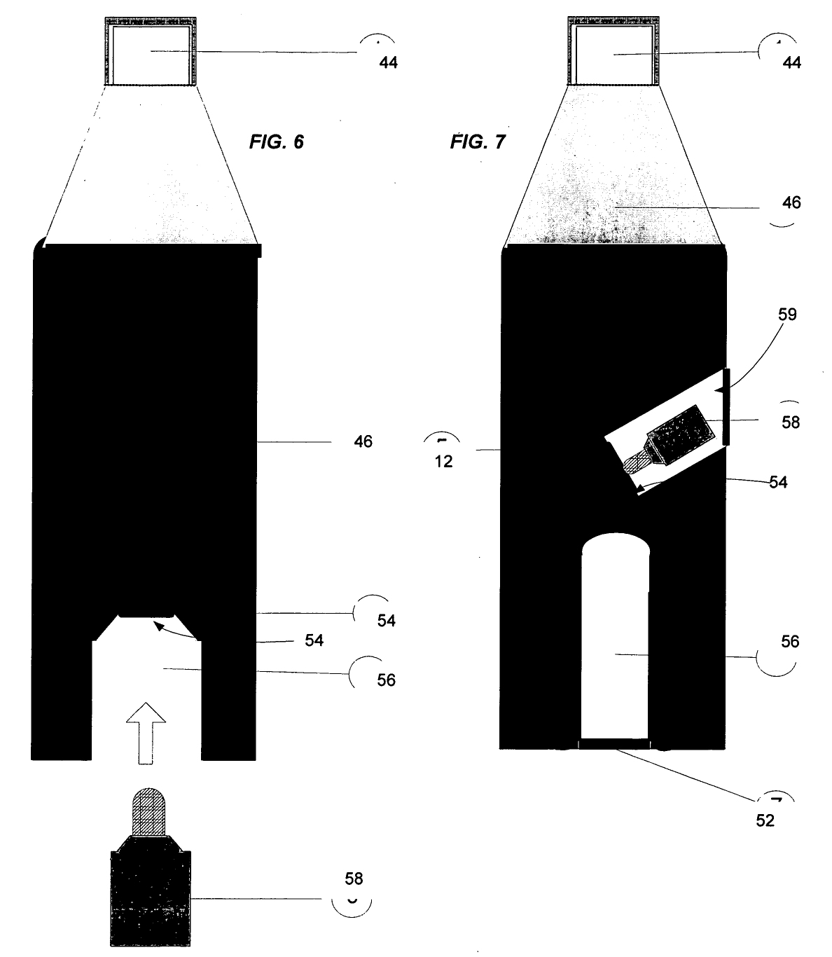

FIG. 6 shows a profile view of another embodiment of a bottle bottom pocket. Elements which are basically the same as that of FIGS. 4 and 5 maintain the same numbers. In FIG. 6, however, a cartridge 58 is shown may conveniently mate with a bottom pocket 56. Alternatively, the same may mate with side pocket 59 (see FIG. 7, which shows a profile view of a bottle side and bottom pockets). In any case, the cartridge may be released at a penetration and release point 54, which may be soft or hard depending on the use and on the method the cartridge component uses, if used, to release its contents into the bottle, e.g., injection.

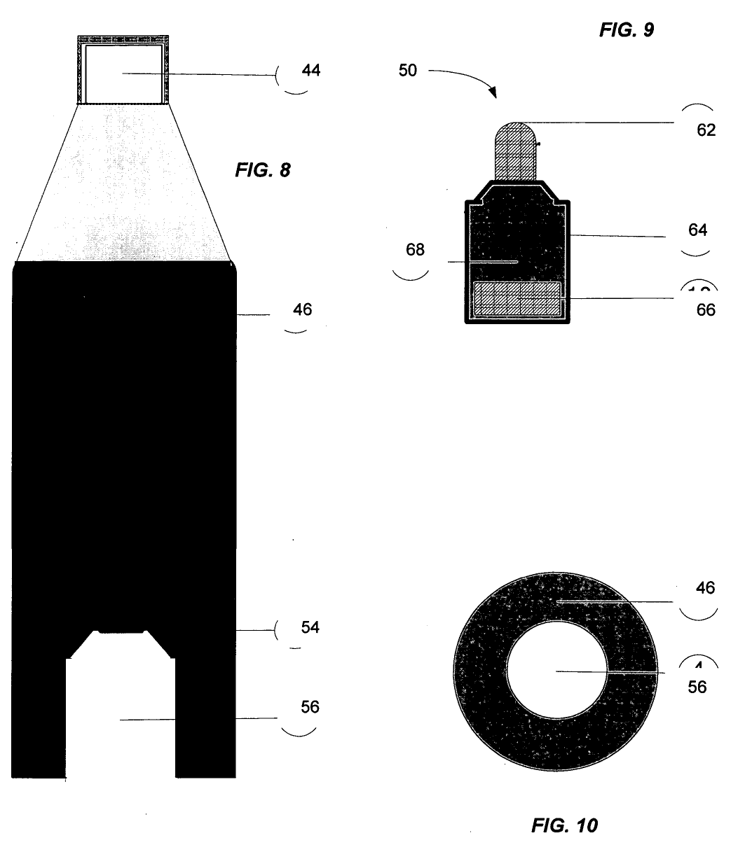

FIGS. 8-10 show a bottle with a bottom pocket, an example of a cartridge to be used in pockets, and a view of the bottom of the bottle showing the carrier pocket and bottle inner-space, respectively.

The bottle may be produced with these several components built to appropriate sizes.

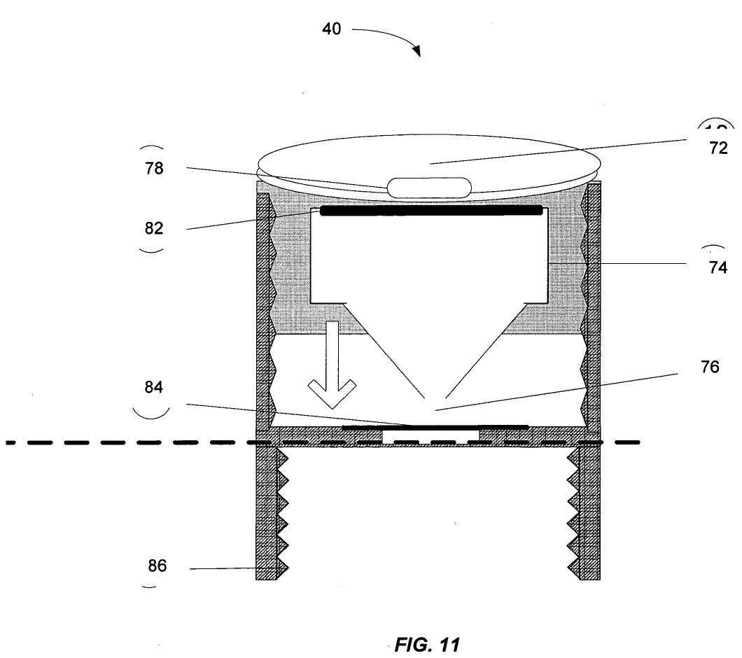

The multifunctional cap 40, shown in FIG. 11 and discussed in more detail below, may be applied to any bottle and may provide functions of storage and/or direct release in to bottle, and may be used with substances in any form such as vitamins, liquids, dissolved capsules, flavors, food supplements, organic and natural products, drugs, alternative medicine remedies and essences.

The components may be assembled in the following exemplary manner. The bottle with its pockets may be manufactured in a known fashion. The advertising or other media, e.g., brochures, labels, banners, coupons, lottery tickets, promotion materials, self-powered microprocessors and/or illumination devices, glow devices, and/or sound effects are inserted into the cylinder pocket 48 and any other products, merchandising and carriers containing any additives are inserted in to pocket 56. Pocket cover 52 e.g.—an adhesive closure, is applied in order to close and seal pockets 48 and 56. The bottle may then be filled with water or another beverage and may be sealed with a regular cap or a multifunctional cap as discussed below. Alternatively, this step can be done as the first step as well.

The components may be used by consumers in the following exemplary manner to achieve the desired result. The consumer may open the pockets by pulling the pocket cover from all pockets of the bottle. The consumer can then pull and reveal the content in the pockets. The consumer can also easily remove the contents from the pocket by pulling the same out or by pouring it out. The consumer can also use the contents in the supplied cartridge 50 by pulling, pushing, turning, or pressing keys or other devices depending on the cartridge mechanism e.g.—by pressing the injection key with her finger the consumer can inject and or release the cartridge contents into the bottle via the penetration and release points. Alternatively, the consumer can use the multifunctional cap 40 in order to release its content within a cap storage space 74 by activating a pressure mechanism 82 and via the soft penetration point 84 e.g.—thus injecting the liquid or releasing any other substance into the bottle. Once the contents have been released into the bottle in any of the above applications, the consumer may shake the bottle, open the multifunctional cap, and drink its content.

There are several alternative methods for using and assembling embodiments of the invention, including the following.

Embodiments may be designed to be applied to many different types of bottles or containers and various beverage combinations other than bottled water, (e.g., those containing soft-drinks, spirits, wine, beer, milk and juice bottles/cartons and personal care/cosmetics, detergents or any other liquids in containers. Embodiments may be bifurcated into two or more parts which can be used in a mutually exclusive manner, e.g., any mentioned component can be used separately and or in combination with any other component e.g.—cylinder pockets can be used with or without cartridges or multifunctional caps. The bottle can also be manufactured with none, one or more pockets, with or without the multifunctional cap, etc. The disclosed components can be used as stand-alone components to deliver the requisite media, merchandising and/or products. Pockets can be used without covers. The cylinder pocket and/or carrier pocket can have their own source of electrical power, using technologies such as “power paper” as well as built-in microprocessors for multi-media effects (e.g., illumination, sound, holograms, etc.) to be combined in the pockets. Bottle Pockets can be manufactured as one piece molds or via any other manufacturing techniques. Types of additives in any forms—solids, gases or liquids—may be delivered with any component of the invention e.g—carrier pockets can contain the following but are not limited to: certain beneficial substances, e.g., drugs, vitamins, organic or natural products and/or supplements, alternative medicine and energetic additives, vibrational essences, etc. Any component can be disposable or susceptible to multiple use. The multifunctional cap can be covered with sealing nylon or with any other material for protection.

While certain embodiments have been described, the invention is limited only by the claims appended hereto. For example, various alterations may be made which still fall within the scope of the current invention. For example, a dry compartment may be included that extends from the top to the bottom of the bottle. Another dry compartment may be attached via a simple screw or any other mechanism to the bottom of the main cap in such way that the user will open the cap to consume the beverage and will be able to use/consume the dry container content by unscrewing the container from the cap after the main cap is removed.

A cap may be provided with additives that can be sold separately. In this way, a package of caps with various additives to be used in generic bottles of water may be “mixed and matched”. These caps may release their additive into the beverage upon a pushing or pulling or turning of a button on the cap as described above.

1. I claim the above as described.
